(19) United States
(12) Patent Application Publication
(10) Pub. No.: US 2008/0127463 A1
(43) Pub. Date: Jun. 5, 2008

(54) FASTENER AND HEAT DISSIPATION DEVICE USING THE SAME

(75) Inventors: LIANG-HUI ZHAO, Shenzhen (CN); YI-QIANG WU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignee: FOXCONN TECHNOLOGY CO., LTD., Taipei Hsien (TW)

(21) Appl. No.: 11/565,508

(22) Filed: Nov. 30, 2006

(51) Int. Cl. F16B 2/00; F16B 39/00

(52) U.S. Cl. 24/457; 411/81

(57) ABSTRACT

A fastener (20) comprises a fixing post (21) and a washer (25). The fixing post has a locking tongue (213) and a slot (2110) just above the locking tongue. The washer defines a hole (253) and has at least one tab (255) near the hole. The fixing post extends through a heat sink (100) and engages with the washer by fitting the washer into the slot, whereby the washer is sandwiched between the locking tongue and a base (12) of the heat sink and the fixing post is securely attached to the heat sink. The tab engages with a straight side of the locking tongue. The fixing post is used for threadedly engaging with a screw thereby attaching the heat sink to an electronic device mounted on a printed circuit board.

### BACKGROUND OF THE INVENTION

1. Field of the Invention

The present invention relates generally to a fastener for a heat dissipation device, and particularly to a fastener that can be fixed to the heat dissipation device to attach the heat dissipation device to another assembly.

2. Description of Related Art

Electronic devices such as central processing units (CPUs) generate a lot of heat during normal operation. If the heat generated by the electronic devices is not timely and properly dissipated it can affect their operational stability and damage associated electronic devices. A heat dissipation device is often attached to a top surface of the CPU secured on a printed circuit board to remove the heat from the CPU to ensure the normal operation of the CPU.

Generally, a fastener is used to secure the heat dissipation device on the printed circuit board. However, most of the related fasteners cannot be securely fixed on the heat dissipation device. Thus the related fastener mounted on the heat dissipation device may easily become detached from the heat dissipation device during transportation. Furthermore, assembling the heat dissipation device with the related fastener is a troublesome and laborious process.

### SUMMARY OF THE INVENTION

A fastener comprises a fixing post and a washer. The fixing post has a locking tongue formed thereon, with a slot defined in the fixing post adjacent to the locking tongue. A washer defines a hole therein and has at least one tab formed extending toward the hole. The fixing post is attached to a heat sink by having the washer fitted into the slot and the tab engaging with a straight side of the tongue. A screw is used to extend upwardly through a printed circuit board and thereadedly engage with the fixing post, whereby the heat sink is securely mounted on a heat-generating electronic component on the printed circuit board.

Other advantages and novel features of the present heat dissipation device will become more apparent from the following detailed description of the preferred embodiment when taken in conjunction with the accompanying drawings, in which:

### BRIEF DESCRIPTION OF THE DRAWINGS

Many aspects of the present device can be better understood with reference to the following drawings. The components in the drawings are not necessarily drawn to scale, the emphasis instead being placed upon clearly illustrating the principles of the present device. Moreover, in the drawings, like reference numerals designate corresponding parts throughout the several views.

FIG. 1 is an assembled, isometric view of a heat dissipation device in accordance with a preferred embodiment of the present invention;

FIG. 2 is similar to FIG. 1, but shown from an opposite bottom aspect;

FIG. 3 is an exploded, isometric view of FIG. 2;

FIG. 4 is a cross-sectional view of a fixing post of a fastener of the heat dissipation device of FIG. 3, taken along line IV-IV thereof;

FIG. 5 is a cross-sectional, isometric view of the fastener in an unlocked position; and

FIG. 6 is a cross-sectional, isometric view of the fastener in a locked position, taken along line VI-VI of FIG. 2;

### DETAILED DESCRIPTION OF THE INVENTION

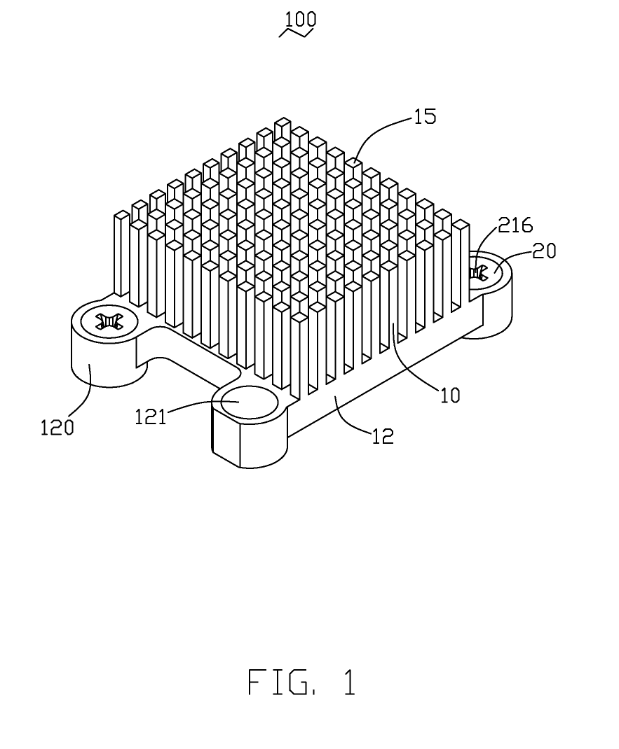

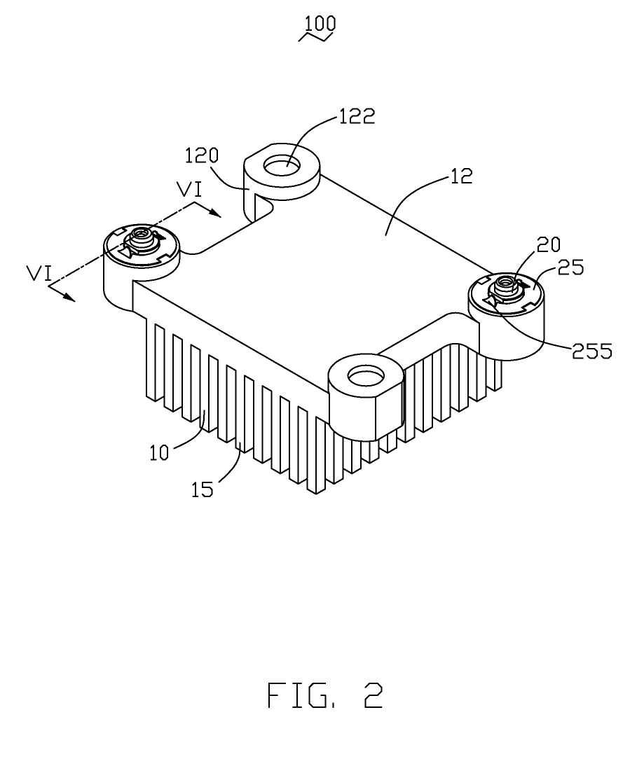

As shown in FIG. 1 and FIG. 2, a heat dissipation device 100 in accordance with a preferred embodiment of the present invention is configured (i.e., structured and arranged) for dissipating heat generated by a heat generating device (not shown), such as a CPU on a printed circuit board (not shown). The heat dissipation device 100 comprises a heat sink 10 and two fasteners 20. The fasteners 20 can be fixed to the heat sink 10 and used to secure the heat sink 10 on the heat-generating device on the printed circuit board.

The heat sink 10 comprises a square base 12 and a plurality of parallel fins 15 extending vertically and upwardly from a top surface of the base 12. All of the fins 15 are rod-like and spaced from each other. Each fin 15 has a square cross-section in a horizontal direction. Four ears 120 adjacent to four corners of the base 12 extend out from two opposite sides (not labeled) of the base 12 in the horizontal direction. The four ears 120 each have a cylindrical configuration and define a stepped hole 121 therein. The stepped hole 121 comprises an upper hole (not labeled) adjacent to the fins 12 and a lower hole (not labeled) having a smaller diameter than the upper hole. Thus a step 123 is formed between the upper hole and the lower hole.

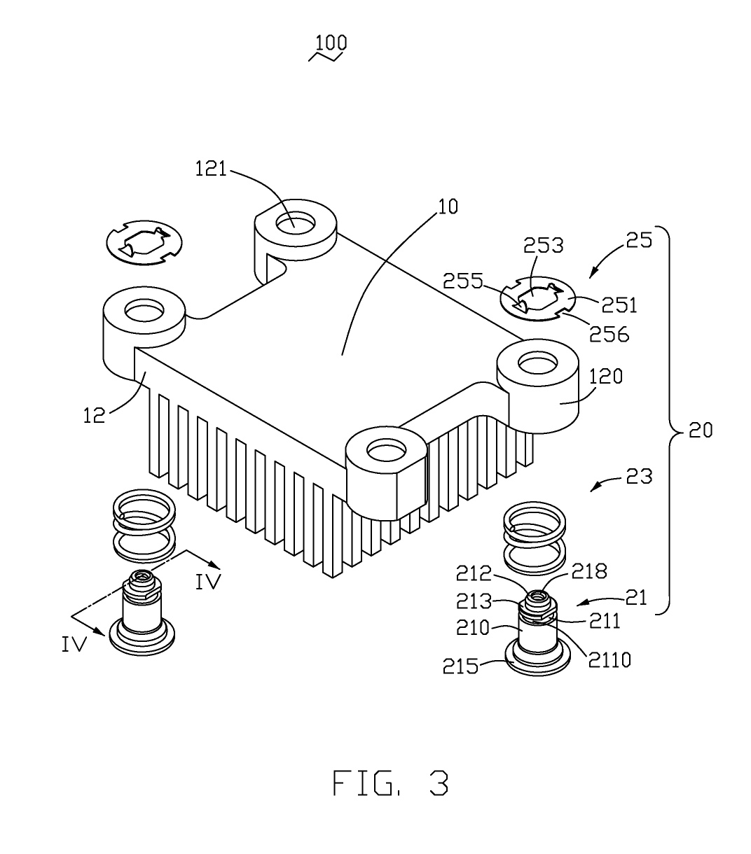

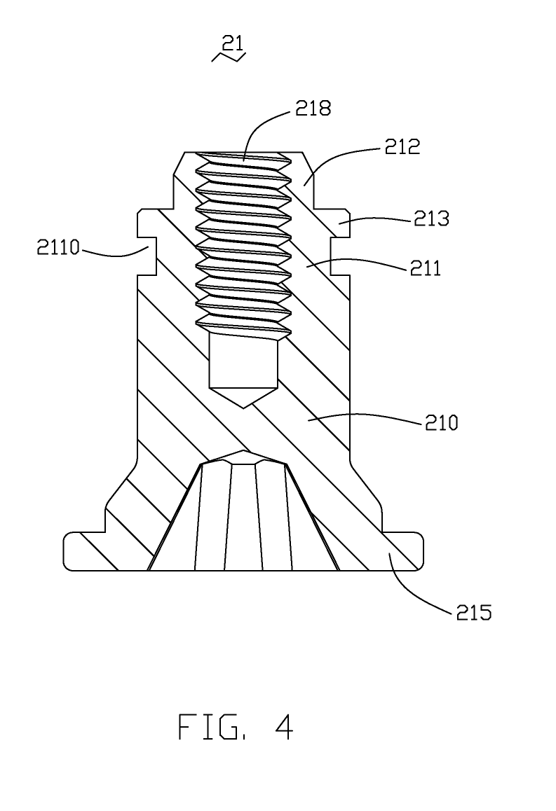

As shown in FIG. 3 and FIG. 4, each fastener 20 comprises a fixing post 21, a washer 25 engaging with the fixing post 21 and a spring 23 to be received in the upper hole of a corresponding stepped hole 121.

The fixing post 21 has a shaft-like configuration. The fixing post 21 has a cylindrical shaft portion 210. A cap 215 is formed on a top end of the shaft portion 210. A cross-like slot 216 is defined in the cap 215 for fittingly receiving a screwdriver (not shown), thus the fixing post 21 can be manipulated. From another end opposite to the cap 215 of the shaft portion 210, an engaging portion 211 vertically and coaxially extends from a bottom end of the shaft portion 210. The engaging portion 211 has a smaller diameter than that of the shaft portion 210. A cylindrical extension portion 212 vertically and coaxially extends from a free end of the engaging portion 211. The extension portion 212 has a smaller diameter than that of the engaging portion 211. A locking tongue 213 is circumferentially formed at a joint of the engaging portion 211 and the extension portion 212 of the fixing post 21. The locking tongue 213 has an annular configuration with two vertical sections cut away symmetrically from two opposite sides thereof. Thus a periphery of the locking tongue 213 is enclosed by two opposite arc sides in a longitudinal direction and two opposite straight sides connecting the arc sides in a latitudinal direction. A diameter of the arc sides of the locking tongue 213 is substantially equal to the external diameter of the shaft portion 210. Thus a slot 2110 is circumferentially defined between the locking tongue 213 and the shaft portion 210 and around the engaging portion 211. A threaded hole 218 is defined in the extension portion 212 extending into the shaft portion 210 of the fixing post 21. The threaded hole 218 of the fixing post 21 is adapted to receive a screw (not shown) engaged with the printed circuit board, thereby connecting the fixing post 21 and accordingly the heat dissipation device 100 to the printed circuit board.

The spring 23 is substantially spiral. An internal diameter of the spring 23 is larger than the external diameter of the shaft portion 210 and smaller than an external diameter of the cap 215; thus, the spring 23 can be disposed around the shaft portion 210 and abuts against the cap 215 of the fixing post 21. An external diameter of the spring 23 is smaller than an internal diameter of the upper hole and larger than the lower hole of the stepped hole 121 of the base 12. Accordingly, when the spring 23 is accommodated in the stepped hole 121, a bottom end of the spring 23 sits on the step 123.

The washer 25 may be made of metal or plastic. The washer 25 is a substantially circular piece and comprises a circular base 251. A central hole 253 is defined in the base 251. An outline of the hole 253 is enclosed by two opposite arc sides and two opposite straight sides which are similar to that of the locking tongue 213 and slightly larger than the locking tongue 213 of the fixing post 21. Two triangular tabs 255 extend outwardly from the two arc sides of the hole 253 and can be turned upward or turned downwards relative to the base 251. The base 251 has two square cutouts 256 defined in a circumferential periphery therein, corresponding to the two opposite straight sides of the hole 253. When the washer 25 is assembled to the fixing post 21 by fitting the washer 25 in the slot 2110, the spring 23 can be elastically compressed between the cap 215 and the step 123.

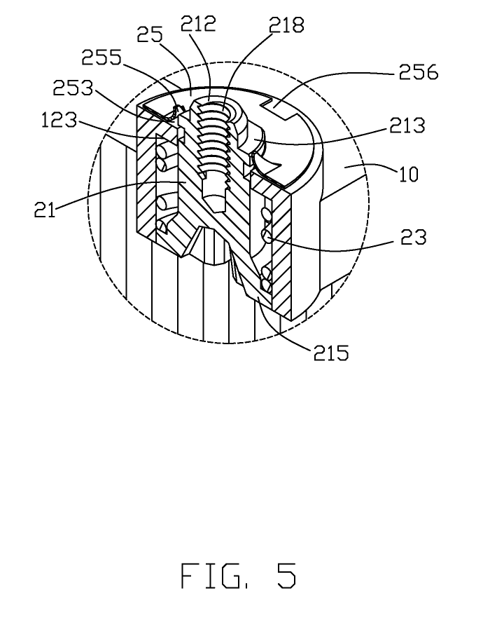

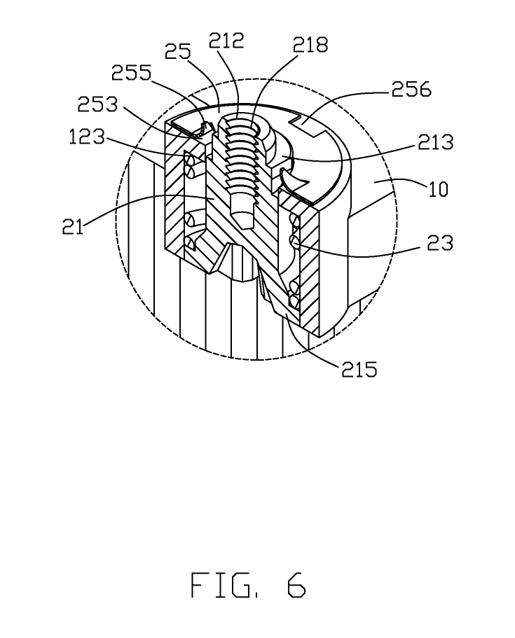

Referring to FIG. 5 and FIG. 6, in assembly, the two springs 23 are firstly each arranged in a stepped hole 121 of the two ears 120, and the bottom end of the spring 23 is disposed on the step 123 of the base 12. Secondly, the fixing post 21 are extended through the spring 23 and the stepped hole 121 from the top surface of the base 12, until the slot 2110 of the fixing post 21 is completely exposed out of a bottom surface (not labeled) of the base 12, meanwhile the cap 215 of the fixing post 21 compresses the spring 23 abutting against the step 123 with a compression force exerted on the step 123 that gradually strengthens. Thirdly, the washer 25 is placed around the extension portion 212, the hole 253 corresponding to the locking tongue 213, and then pushed upwards along an axis of the fixing post 21, until the circular base 251 reaches a position corresponding to the slot 2110 of the fixing post 21. The washer 25 is then rotated 900 relative to the fixing post 21 or the fixing post 21 is rotated 900 relative to the washer 25, causing upper surfaces of the locking tongue 213 corresponding to the arc sides of the locking tongue 213 to be moved to press against a bottom surface of the washer 25 corresponding to the straight sides of the washer 25. Finally, the tabs 255 of the washer 25 are compressed towards the straight sides of the fixing post 21. Then the tabs 255 are positioned adjacent to or abutting against the straight sides of the fixing post 21. Thus the tabs 255 cooperate with the locking tongue 213 to restrict relative movement between the fixing post 21 and the washer 25. Thus the washer 25 is securely engaged to the fixing post 21; furthermore, the fastener 20 is securely fixed to the heat sink 10.

Disassembly is carried out by detaching the tabs 255 of the washer 25 from the straight sides of the fixing post 21. Firstly a screwdriver is used to abut against the fixing post 21 to push the locking tongue 213 of the fixing post 21 apart from the washer. The washer 25 is then rotated 900 relative to the fixing post 21 or the fixing post 21 is rotated 90° relative to the washer 25, to cause the arc sides of the locking tongue 213 to be positioned in aligned with the arced sides of the central hole 253 of the washer 25. Finally, the washer 25 is removed from the fixing post 21 along the axis of the fixing post 21. Thus the fixing post 21 can be detached from the heat sink 10.

In assembly of the heat dissipation device 100, the heat sink 10 combined with the fasteners 20 is disposed on the heat generating device, with the fasteners 20 spatially corresponding to a plurality of holes (not shown) defined in the printed circuit board, a plurality of screws (not shown) are then placed in the holes of the printed circuit board from a bottom side of the printed circuit board and engaged in the threaded holes 218 of the fixing posts 21. Thus the heat dissipation device 100 can be securely attached to the printed circuit board and have an intimate contact with the heat generating device.

Alternatively, the fastener 20 can be fixed to a plate or other components, such as a back plate on the bottom side of the printed circuit board by extending a plurality of screws of the back plate through the printed circuit board to engage in the threaded holes 218 of the fixing posts 21.

It is to be understood, however, that even though numerous characteristics and advantages of the present heat dissipation device have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A fastener comprising:
a fixing post having a locking tongue formed thereon, with a slot defined in the fixing post adjacent to the locking tongue; and
a washer defining a hole therein and forming at least one tab extending toward the hole;
wherein the fixing post and the washer are nested with each other in the slot and the hole, and the tab cooperates with the locking tongue to prevent movement between the fixing post and the washer.

2. The fastener as claimed in claim 1, further comprising a spring mounted around the fixing post and disposed below the washer.

3. The fastener as claimed in claim 1, wherein the fixing post comprises a shaft portion and an engaging portion extending from a free end of the shaft portion, an external periphery of the engaging portion is smaller than that of the shaft portion, the locking tongue horizontally extends from an edge of an end of the engaging portion, a slot is circumferentially defined between the locking tongue and the shaft portion.

4. The fastener as claimed in claim 3, wherein a periphery of the locking tongue is enclosed by two opposite arc sides in a longitudinal direction and two opposite straight sides connecting the arc sides in a latitudinal direction.

5. The fastener as claimed in claim 3, wherein the washer comprises a circular base and a hole defined therein, an outline of the hole is slightly larger than and similar to the locking tongue of the fixing post, the tab extends outwardly from an edge of the hole.

6. The fastener as claimed in claim 3, wherein an extension portion vertically extends from the end of the engaging portion adjacent to the locking tongue, the extension portion has a smaller external periphery than that of the engaging portion.

7. The fastener as claimed in claim 6, wherein a threaded hole is defined in the extension portion extending into the shaft portion of the fixing post.

8. The fastener as claimed in claim 3, wherein a cap is formed at an end of the shaft portion opposite to the engaging portion of the fixing post, and a cross-like slot is defined in the cap.

9. A heat dissipation device comprising:
a heat sink having a base and a plurality of holes defined in the base; and
a plurality of fasteners each comprising:
a fixing post having a locking tongue formed thereon, with a slot defined in the fixing post adjacent to the locking tongue; and
a washer defining a hole therein and forming at least one tab extending toward the hole;
wherein the fixing post extends through each of the holes in the base of the heat sink, the fixing post and the washer are nested with each other in the slot and the hole, and the tab cooperates with the locking tongue to prevent movement between the fixing post and the washer.

10. The heat dissipation device as claimed in claim 9, further comprising a spring mounted around the fixing post and disposed below the washer.

11. The heat dissipation device as claimed in claim 10, wherein the fixing post comprises a shaft portion and an engaging portion extending from a free end of the shaft portion, an external periphery of the engaging portion is smaller than that of the shaft portion, the locking tongue horizontally extends from an edge of an end of the engaging portion, a slot is circumferential defined between the locking tongue and the shaft portion.

12. The fastener as claimed in claim 11, wherein a periphery of the locking tongue is enclosed by two opposite arc sides in a longitudinal direction and two opposite straight sides connecting the arc sides in a latitudinal direction.

13. The fastener as claimed in claim 11, wherein the washer comprises a circular base and a hole defined therein, an outline of the hole is slightly larger than and similar to the locking tongue of the fixing post, the tab extends outwardly from an edge of the hole.

14. The fastener as claimed in claim 11, wherein an extension portion vertically extends from the end of the engaging portion adjacent to the locking tongue, the extension portion has a smaller external periphery than that of the engaging portion.

15. The fastener as claimed in claim 14, wherein a threaded hole is defined in the extension portion extending into the shaft portion of the fixing post.

16. The fastener as claimed in claim 11, wherein a cap is formed in an end of the shaft portion opposite to the engaging portion of the fixing post, and a cross-like slot is defined in the cap.

17. The heat dissipation device as claimed in claim 10, wherein the heat sink comprises a square base and a plurality of parallel fins extending vertically and outwardly from a top surface of the base, all of the fins are rod-like and spaced from each other both in a latitudinal direction and a longitudinal direction.

18. The heat dissipation device as claimed in claim 17, wherein four ears being adjacent to four corners of the base extend out from two opposite sides of the base, each of ears defines a stepped hole therein, each stepped hole comprises an upper hole adjacent to the fins and a lower hole having a smaller diameter than the upper hole, the spring abuts against the step surface of the stepped hole.

19. A heat dissipation device comprising:
a heat sink having a base and a plurality of fins on the base, the base defining at least a stepped hole therein;
at least a fixing post received in the at least a stepped hole, wherein the at least a fixing post has a top cap, a shaft extending downwardly from the cap, and a locking tongue formed near a bottom end of the at least a fixing post, the locking tongue having at least a straight side;
at least a spring surrounding the shaft and compressed between a step formed in the stepped hole of the base of the heat sink and the cap of the at least a fixing post; and
at least a washer having a hole and a tab extending toward the hole, the hole having at least a straight side;
wherein the at least a washer is sandwiched between the locking tongue and a bottom of the base of the heat sink, the tab of the at least a washer engages with the at least a straight side of the locking tongue, and the at least a straight side of the hole is oriented at a direction different from that of the at least a straight side of the locking tongue.

20. The heat dissipation device as claimed in claim 19, wherein the at least a stepped hole has a large upper hole and a small lower hole, and wherein the at least a fixing post has a thread formed at the bottom end thereof.
